(19) United States
(12) Patent Application Publication
(10) Pub. No.: US 2010/0082724 A1
(43) Pub. Date: Apr. 1, 2010

(54) Method For Solving Reservoir Simulation Matrix Equation Using Parallel Multi-Level Incomplete Factorizations

(76) Inventors: Oleg Diyankov, Troitsk (RU); Vladislav Pravilnikov, Troitsk (RU); Sergey Koshelev, The Hague (NL); Natalya Kuznetsova, Troitsk (RU); Serguei Maliassov, Spring, TX (US)

Correspondence Address: Exxon Mobil Upstream;Research Company, P.O. Box 2189, (CORP-URC-SW 359), Houston, TX, 77252-2189, US

(21) Appl. No.: 12/505,275

(22) Filed: Jul. 17, 2009

Related U.S. Application Data
(60) Provisional application No. 61/101,494, filed on Sep. 30, 2008.

(51) Int. Cl. G06F 7/32

(52) U.S. Cl. 708/520

(57) ABSTRACT

A parallel-computing iterative solver is provided that employs a preconditioner that is processed using parallel-computing for solving linear systems of equations. Thus, a preconditioning algorithm is employed for parallel iterative solution of a large sparse system of linear system of equations (e.g., algebraic equations, matrix equations, etc.), such as the linear system of equations that commonly arise in computer-based 3D modeling of real-world systems (e.g., 3D modeling of oil or gas reservoirs, etc.). A novel technique is proposed for application of a multi-level preconditioning strategy to an original matrix that is partitioned and transformed to block bordered diagonal form. An approach for deriving a preconditioner for use in parallel iterative solution of a linear system of equations is provided. In particular, a parallel-computing iterative solver may derive and/or apply such a preconditioner for use in solving, through parallel processing, a linear system of equations.

### CROSS-REFERENCE TO RELATED APPLICATION

This application claims the benefit of U.S. Provisional Patent Application 61/101,494 filed 30 Sep. 2008 entitled METHOD FOR SOLVING RESERVOIR SIMULATION MATRIX EQUATION USING PARALLEL MULTI-LEVEL INCOMPLETE FACTORIZATIONS, the entirety of which is incorporated by reference herein.

### TECHNICAL FIELD

The following description relates generally to iterative solvers for solving linear systems of equations, and more particularly to systems and methods for performing a preconditioning procedure in a parallel iterative process for solving linear systems of equations on high-performance parallel-computing systems.

### BACKGROUND

In analyzing many scientific or engineering applications, it is often necessary to solve simultaneously large number of linear algebraic equations, which can be represented in a form of the matrix equation as follows: Ax=b, (hereinafter “Equation (1)”), where A indicates a known square coefficient matrix of dimension n×n, b denotes a known n-dimensional vector generally called the “right hand side,” and x denotes an unknown n-dimensional vector to be found via solving that system of equations. Various techniques are known for solving such linear systems of equations. Linear systems of equations are commonly encountered (and need to be solved) for various computer-based three-dimensional (“3D”) simulations or modeling of a given real-world system. As one example, modern 3D simulation of subsurface hydrocarbon bearing reservoirs (e.g., oil or gas reservoirs) requires the solution of algebraic linear systems of the type of Equation (1), typically with millions of unknowns and tens and even hundreds of millions of non-zero elements in sparse coefficient matrices A. These non-zero elements define the matrix sparsity structure.

Similarly, computer-based 3D modeling may be employed for modeling such real-world systems as mechanical and/or electrical systems (such as may be employed in automobiles, airplanes, ships, submarines, space ships, etc.), human body (e.g., modeling of all or portions of a human's body, such as the vital organs, etc.), weather patterns, and various other real-world systems to be modeled. Through such modeling, potential future performance of the modeled system can be analyzed and/or predicted. For instance, the impact that certain changed conditions presented to the modeled system has on the system's future performance may be evaluated through interaction with and analysis of the computer-based model.

As an example, modeling of fluid flow in porous media is a major focus in the oil industry. Different computer-based models are used in different areas in the oil industry, but most of them include describing the model with a system of partial differential equations (PDE's). In general, such modeling commonly requires discretizing the PDE's in space and time on a given grid, and performing computation for each time step until reaching the prescribed time. At each time step, the discrete equations are solved. Usually the discrete equations are nonlinear and the solution process is iterative. Each step of the nonlinear iterative method typically includes linearization of the nonlinear system of equations (e.g., Jacobian construction), solving the linear system, and property calculations, that are used to compute the next Jacobian.

FIG. 1 shows a general work flow typically employed for computer-based simulation (or modeling) of fluid flow in a subsurface hydrocarbon bearing reservoir over time. The inner loop 101 is the iterative method to solve the nonlinear system. Again, each pass through inner loop 101 typically includes linearization of the nonlinear system of equations (e.g., Jacobian construction) 11, solving the linear system 12, and property calculations 13, that are used to compute the next Jacobian (when looping back to block 11). The outer loop 102 is the time step loop. As shown, for each time step loop boundary conditions may be defined in block 10, and then after performance of the inner loop 101 for the time step results computed for the time step may be output in block 14 (e.g., the results may be stored to a data storage media and/or provided to a software application for generating a display representing the fluid flow in the subsurface hydrocarbon bearing reservoir being modeled for the corresponding time step). As mentioned above, computer-based 3D modeling of real-world systems other than modeling of fluid flow in a subsurface hydrocarbon bearing reservoir may be performed in a similar manner, i.e., may employ an iterative method for solving linear systems of equations (as in block 12 of FIG. 1).

The solution of the linear system of equations is a very computationally-intensive task and efficient algorithms are thus desired. There are two general classes of linear solvers: 1) direct methods and 2) iterative methods. The so-called “direct method” is based on Gaussian elimination in which the matrix A is factorized, where it is represented as a product of lower triangular and upper triangular matrices (factors), L and U, respectively: A=LU (hereinafter “Equation (2)”). However, for large sparse matrices A, computation of triangular matrices L and U is very time consuming and the number of non-zero elements in those factors can be very large, and thus they may not fit into the memory of even modern high-performance computers.

The “iterative method” is based on repetitive application of simple and often non-expensive operations like matrix-vector product, which provides an approximate solution with given accuracy. Usually, for the linear algebraic problems of the type of Equation (1) arising in scientific or engineering applications, the properties of the coefficient matrices lead to a large number of iterations for converging on a solution.

To decrease a number of iterations and, hence, the computational cost of solving matrix equation by the iterative method, a preconditioning technique is often used, in which the original matrix equation of the type of Equation (1) is multiplied by an appropriate preconditioning matrix M (which may be referred to simply as a “preconditioner”), such as: M⁻¹Ax=M⁻¹b (hereinafter “Equation (3)”). Here, M⁻¹ denotes an inverse of matrix M. Applying different preconditioning methods (matrices M), it may be possible to substantially decrease the computational cost of computing an approximate solution to Equation (1) with a sufficient degree of accuracy. Major examples of preconditioning techniques are algebraic multi-grid methods and incomplete lower-upper factorizations.

In the first approach (i.e., multi-grid methods), a series of coefficient matrices of decreasing dimension is constructed, and some methods of data transfer from finer to coarser dimension are established. After that, the matrix Equation (1) is very approximately solved (so-called “smoothing”), a residue r=Ax−b is computed, and the obtained vector r is transferred to the coarser dimension (so-called “restriction”). Then, the equation analogous to Equation (1) is approximately solved on the coarser dimension, the residue is computed and transferred to the coarser dimension, and so on. After the problem is computed on the coarsest dimension, the coarse solution is transferred back to the original dimension (so-called “prolongation”) to obtain a defect which will be added to the approximate solution on the original fine dimension.

Another example of a preconditioning technique is an incomplete lower-upper triangular factorization (ILU-type), in which instead of full factorization (as in Equation (2)), sparse factors L and U are computed such that their product approximates the original coefficient matrix: A≈LU (hereinafter “Equation (4)”).

Both aforementioned preconditioning techniques are essentially sequential and can not be directly applied on parallel processing computers. As the dimension of the algebraic problems arising in scientific and engineering applications is growing, the need for solution methods appropriate for parallel processing computers becomes more and more important. Thus, the development of efficient parallel linear solvers is becoming an increasingly important task, particularly for many 3D modeling applications such as for petroleum reservoir modeling. In spite of essential progress in many different methods of solving matrix equations with large sparse coefficient matrices, such as multi-grid or direct solvers, in the last decades, the iterative methods with preconditioning based on incomplete lower-upper factorizations are still the most popular approaches for the solution of large sparse linear systems. And, as mentioned above, these preconditioning techniques are essentially sequential and cannot be directly applied on parallel processing computers.

Recently in the scientific community, a new class of parallel preconditioning strategies that utilizes multilevel block ILU factorization techniques was developed for solving large sparse linear systems. The general idea of this new approach is to reorder the unknowns and corresponding equations and split the original matrix into a 2×2 block structure in such a way that the first diagonal block becomes a block diagonal matrix. This block can be factorized in parallel. After forming the Schur complement by eliminating the factorized block, the procedure is repeated for the obtained Schur complement. The efficiency of this new method depends on the way the original matrix and the Schur complement are split into blocks. In conventional methods, multilevel factorization is based on multi-coloring or block independent set splitting of the original graph of matrix sparsity structure. Such techniques are described further in: a) C. Shen, J. Zhang and K. Wang. Distributed block independent set algorithms and parallel multi-level ILU preconditioned. J. Parallel Distrib. Comput. 65 (2005), pp 331-346; and b) Z. Li, Y. Saad, and M. Sosonkina., pARMS: A parallel version of the algebraic recursive multilevel solver, Numer. Linear Algebra Appl., 10 (2003), pp. 485-509, the disclosures of which are hereby incorporated herein by reference. A disadvantage of these approaches is that they change the original ordering of the matrix, which in many cases leads to worse quality of preconditioner and/or slower convergence of the iterative solver. Another disadvantage is that construction of such a reordering in parallel is not well scalable, i.e. its quality and efficiency deteriorates significantly with increasing the number of processing units (processors).

Another class of parallel preconditioning strategies based on ILU factorizations utilizes ideas arising from domain decomposition. Given a large sparse system of linear Equations (1), first, using a partitioning software (for example, METIS, as described in G. Karypis and V. Kumar, METIS: Unstructured Graph Partitioning and Sparse Matrix Ordering System, Version 4.0, September 1998, the matrix A is split into a given number of sub-matrices p with almost the same number of rows in each sub-matrix and small number of connections between sub-matrices. After the partitioning step, local reordering is applied, first, to order interior rows for each sub-matrix and then, their “interface” rows, i.e. those rows that have connections with other sub-matrices. Then, the partitioned and permuted original matrix A can be represented in the following block bordered diagonal (BBD) form:

$${QAQ}^{T} = [ \begin{matrix}{A}_{1} & & & & {F}_{1} \\ & {A}_{2} & & & {F}_{2} \\ & & ⋱ & & ⋮ \\ & & & {A}_{P} & {F}_{P} \\ {C}_{1} & {C}_{2} & … & {C}_{P} & B\end{matrix} ] ,$$

where Q is a permutation matrix having local permutation matrices Q₁, and matrix B is a global interface matrix which contains all interface rows and external connections of all sub-matrices and has the flowing structure:

$$B = [ \begin{matrix}{B}_{1} & {A}_{12} & … & {A}_{1 p} \\ {A}_{21} & {B}_{2} & & \\ ⋮ & & ⋱ & \\ {A}_{p 1} & & & {B}_{p}\end{matrix} ] .$$

Such a form of matrix representation is widely used in scientific computations, see e.g.: a) D. Hysom and A, Pothen, A scalable parallel algorithm for incomplete factor preconditioning, SIAM J. Sci. Comput., 22 (2001), pp. 2194-2215 (hereinafter referred to as “Hysom”); b) G. Karypis and V. Kumar. Parallel Threshold-based ILU Factorization. AHPCRC, Minneapolis, Minn. 55455, Technical Report #96-061 (hereinafter referred to as “Karypis”); and c) Y. Saad, Iterative Methods for Sparse Linear Systems, 2nd ed, SIAM, Philadelphia, 2003 (hereinafter referred to as “Saad”).

The next step of parallel preconditioning based on BBD format is a factorization procedure. There are several approaches to factorization. One approach is considered in, e.g.: Hysom and Karypis. In Hysom, first, the interior rows are factorized in parallel. If for some processing unit there are no lower-ordered connections, then boundary rows are also factorized. Otherwise, a processing unit waits for the row structure and values of low-ordered connections to be received, and only after that, boundary rows are factorized. Accordingly, this scheme is not time-balanced very well because processing units with higher index have to wait for factorized boundary rows from neighboring processing units with smaller indices. Thus, with increasing number of processing units, the scalability of the method deteriorates.

In Karypis, the factorization of upper part of the matrix in BBD format is performed in parallel while factorization of lower rectangular part └C₁ C₂ . . . Cₚ B┘ is performed using parallel maximal independent set reordering of block B, which can be applied several times. After that, modified parallel version of incomplete factorization procedure is applied to the whole lower part of a matrix. Again, permutation of a part of a matrix using independent set reordering may lead to worse convergence and scalability.

Another approach is described in U.S. Pat. No. 5,655,137 (hereinafter “the '137 patent”), the disclosure of which is hereby incorporated herein by reference. In general, the '137 patent proposes to factorize in parallel the diagonal blocks A₁ through Aₚ in the form Aᵢ=Uᵢ^{T}Uᵢ (Incomplete Cholesky factorization) and then use these local factorizations to compute Schur complement of the matrix B. This approach can be applied only to symmetric positive definite matrices.

A very different approach described in Saad applies truncated variant of ILU factorization to factorize the whole sub-matrices including boundary rows in such a way that for each i-th sub-matrix a local Schur complement Sᵢ is computed, and global Schur complement is obtained as a sum of local Schur complements. As result, the Schur complement matrix is obtained in the following form:

$$S = [ \begin{matrix}{S}_{1} & {A}_{12} & & {A}_{1 p} \\ {A}_{21} & {S}_{2} & & \\ & & … & \\ {A}_{p 1} & & & {S}_{p}\end{matrix} ] .$$

Methods of this type have two major drawbacks. First, the size of the Shur complement S grows dramatically when the number of parts is increased. The second problem is the efficient factorization of matrix S.

A desire exists for an improved iterative solving method that enables parallel processing of multi-level incomplete factorizations.

### SUMMARY

The present invention is directed to a system and method which employ a parallel-computing iterative solver. Thus, embodiments of the present invention relate generally to the field of parallel high-performance computing. Embodiments of the present invention are directed more particularly to preconditioning algorithms that are suitable for parallel iterative solution of large sparse systems of linear system of equations (e.g., algebraic equations, matrix equations, etc.), such as the linear system of equations that commonly arise in computer-based 3D modeling of real-world systems (e.g., 3D modeling of oil or gas reservoirs, etc.).

According to certain embodiments, a novel technique is proposed for application of a multi-level preconditioning strategy to an original matrix that is partitioned and transformed to block bordered diagonal form.

According to one embodiment, an approach for deriving a preconditioner for use in parallel iterative solution of a linear system of equations is provided. In particular, a parallel-computing iterative solver may derive and/or apply such a preconditioner for use in solving, through parallel processing, a linear system of equations. As discussed further herein, such a parallel-computing iterative solver may improve computing efficiency for solving such a linear system of equations by performing various operations in parallel.

According to one embodiment, a non-overlapping domain decomposition is applied to an original matrix to partition the original graph into p parts using p-way multi-level partitioning. Local reordering is then applied. In the local reordering, according to one embodiment, interior rows for each sub-matrix are first ordered, and then their “interface” rows (i.e. those rows that have connections with other sub-matrices) are ordered. As result, the local i-th sub-matrix will have the following form:

$$\begin{matrix}{A}_{i} = [ \begin{matrix}{A}_{ii}^{I} & {A}_{ii}^{IB} \\ {A}_{ii}^{BI} & {A}_{ii}^{B}\end{matrix} ] + {\sum }_{j \neq i} {A}_{ij} \\ = [ \begin{matrix}{A}_{i} & {F}_{i} \\ {C}_{i} & {B}_{i}\end{matrix} ] + {\sum }_{i \neq j} {A}_{ij} \\ = {A}_{ii} + {\sum }_{i \neq j} {A}_{ij} ,\end{matrix} \qquad ( hereinafter “ Equation ( 5 ) ” )$$

where Aᵢ is a matrix with connections between interior rows, Fᵢ and Cᵢ are matrices with connections between interior and interface rows, Bᵢ is a matrix with connections between interface rows, and Aᵢⱼ are matrices with connections between sub-matrices i and j. It should be recognized that the matrix Aᵢᵢ corresponds to the diagonal block of the i-th sub-matrix.

In one embodiment, the process performs a parallel truncated factorization of diagonal blocks with forming the local Schur complement for the interface part of each sub-matrix Bᵢ. A global interface matrix is formed by local Schur complements on diagonal blocks and connections between sub-matrices on off-diagonal blocks. By construction, the resulting matrix has a block structure.

The above-described process is then repeatedly applied starting with repartitioning of the interface matrix until the interface matrix is small enough (e.g., as compared against a predefined size maximum). The repartitioning of the interface matrix is performed, in certain embodiments, to minimize the number of connections between the sub-matrices. When determined that the dimension of the interface matrix is small enough, it may be factorized either directly or using iterative parallel (e.g. Block-Jacoby) method.

According to certain embodiments, the algorithm is repetitive (recursive) application of the above-mentioned steps, while implicitly forming interface matrix of size which is larger than some predefined size threshold or the current level number is less than the maximal allowed number of levels. At the same time, before application of the described steps at lower levels, the interface matrix is repartitioned by some partitioner (such as the parallel multi-level partitioner described further herein). Additionally, local diagonal scaling is used before parallel truncated factorization in order to improve numerical properties of the locally factorized diagonal blocks in certain embodiments. As also described herein, more sophisticated local reorderings may be applied in some embodiments. Generally speaking, the algorithm of one embodiment merges algorithms (that are largely known in the art) in one general framework based on repetitive (recursive) application of the sequence of known algorithms to form a sequence of matrices with decreasing dimensions (multi-level approach).

That above-described method utilizing a multi-level approach can be applied as a preconditioner in iterative solvers. In addition, specific local scaling and local reordering algorithms can be applied in order to improve the quality of the preconditioner. The algorithm is applicable for both shared memory and distributed memory parallel architectures.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows a general work flow typically employed for computer-based simulation (or modeling) of fluid flow in a subsurface hydrocarbon bearing reservoir over time;

FIG. 2 shows a block diagram of an exemplary computer-based system implementing a parallel-computing iterative solver according to one embodiment of the present invention;

FIG. 3 shows a block diagram of another exemplary computer-based system implementing a parallel-computing iterative solver according to one embodiment of the present invention; and

FIG. 4 shows an exemplary computer system which may implement all or portions of a parallel-computing iterative solver according to certain embodiments of the present invention.

### DETAILED DESCRIPTION

Embodiments of the present invention relate generally to the field of parallel high-performance computing. Embodiments of the present invention are directed more particularly to preconditioning algorithms that are suitable for parallel iterative solution of large sparse systems of linear system of equations (e.g., algebraic equations, matrix equations, etc.), such as the linear system of equations that commonly arise in computer-based 3D modeling of real-world systems (e.g., 3D modeling of oil or gas reservoirs, etc.).

According to certain embodiments, a novel technique is proposed for application of a multi-level preconditioning strategy to an original matrix that is partitioned and transformed to block bordered diagonal form.

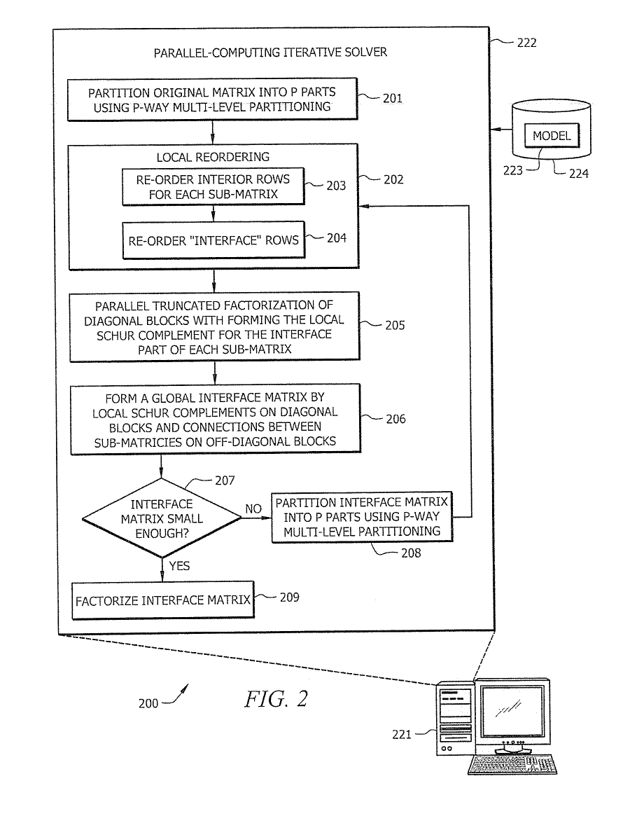

According to one embodiment, an approach for deriving a preconditioner for use in parallel iterative solution of a linear system of equations is shown in FIG. 2. FIG. 2 shows a block diagram of an exemplary computer-based system 200 according to one embodiment of the present invention. As shown, system 200 comprises a processor-based computer 221, such as a personal computer (PC), laptop computer, server computer, workstation computer, multi-processor computer, cluster of computers, etc. In addition, a parallel iterative solver (e.g., software application) 222 is executing on such computer 221. Computer 221 may be any processor-based device capable of executing a parallel iterative solver 222 as that described further herein. Preferably, computer 221 is a multi-processor system that comprises multiple processors that can perform the parallel operations of parallel iterative solver 222. While parallel iterative solver 222 is shown as executing on computer 221 for ease of illustration in FIG. 2, it should be recognized that such solver 222 may be residing and/or executing either locally on computer 221 or on a remote computer (e.g., server computer) to which computer 221 is communicatively coupled via a communication network, such as a local area network (LAN), the Internet or other wide area network (WAN), etc. Further, it should be understood that computer 221 may comprise a plurality of clustered or distributed computing devices (e.g., servers) across which parallel iterative solver 222 may be stored and/or executed, as is well known in the art.

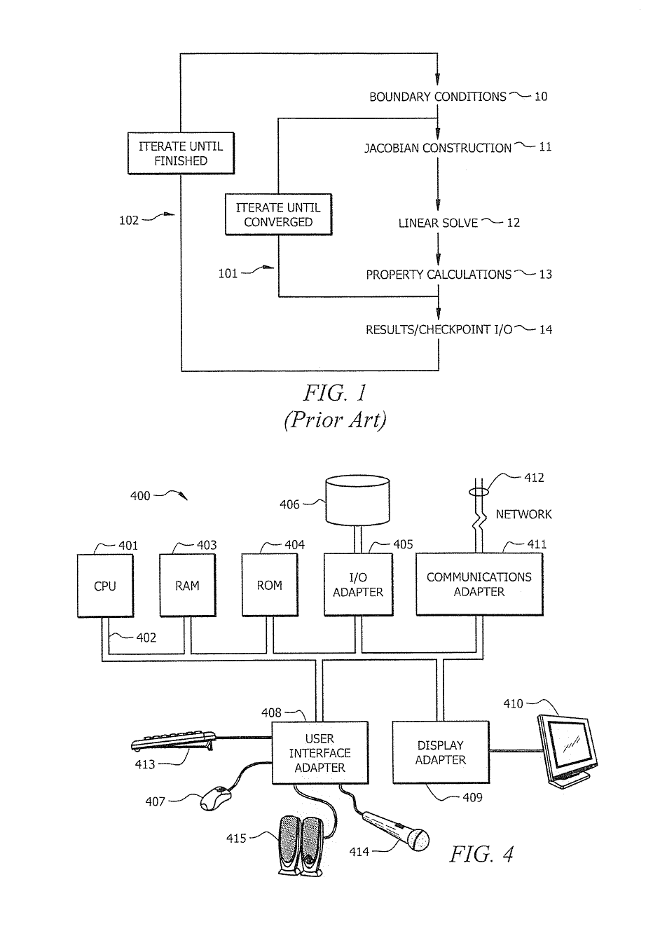

As with many conventional computer-based iterative solvers, parallel iterative solver 222 comprises computer-executable software code stored to a computer-readable medium that is readable by processor(s) of computer 221 and, when executed by such processor(s), causes computer 221 to perform the various operations described further herein for such parallel iterative solver 222. Parallel iterative solver 222 is operable to employ an iterative process for solving a linear system of equations, wherein portions of the iterative process are performed in parallel (e.g., on multiple processors of computer 221). As discussed above, iterative solvers are commonly used for 3D computer-based modeling. For instance, parallel iterative solver 222 may be employed in operational block 12 of the conventional work flow (of FIG. 1) for 3D computer-based modeling of fluid flow in a subsurface hydrocarbon bearing reservoir. In the illustrated example of FIG. 2, a model 223 (e.g., containing various information regarding a real-world system to be modeled, such as information regarding a subsurface hydrocarbon bearing reservoir for which fluid flow over time is to be modeled) is stored to data storage 224 that is communicatively coupled to computer 221. Data storage 224 may comprise a hard disk, optical disc, magnetic disk, and/or other computer-readable data storage medium that is operable for storing data.

As with the many conventional iterative solvers employed for 3D computer-based modeling, parallel iterative solver 222 is operable to receive model information 223 and perform an iterative method for solving a linear system of equations for generating a 3D computer-based model, such as a model of fluid flow in a subsurface hydrocarbon bearing reservoir over time. As discussed further herein, parallel iterative solver 222 may improve computing efficiency for solving such a linear system of equations by performing various operations in parallel. According to one embodiment, parallel iterative solver may perform operations 201-209 discussed below.

As shown in block 201, a non-overlapping domain decomposition is applied to an original matrix to partition the original graph into p parts using p-way multi-level partitioning. It should be recognized that this partitioning may be considered as external with respect to the algorithm because partitioning of the original data is generally a necessary operation for any parallel computation.

In block 202, local reordering is applied. As shown in sub-block 203, interior rows for each sub-matrix are first ordered, and then, in sub-block 204, their “interface” rows (i.e. those rows that have connections with other sub-matrices) are ordered. As result, the local i-th sub-matrix will have the form of Equation (5) above. In addition to (or instead of) local reordering, a local scaling algorithm may also be executed to improve numerical properties of sub-matrices and, hence, to improve the quality of independent truncate factorization, in certain embodiments. In certain embodiments, the local reordering of block 202 is an option of the algorithm, which may be omitted from certain implementations. Local reordering may not only be simple reordering to move interior nodes first and interface nodes last in given natural order, but may be implemented as a more complicated algorithm such as a graph multi-level manner minimizing profile of reordered diagonal block, as mentioned further below.

In block 205, the process performs a parallel truncated factorization of diagonal blocks with forming the local Schur complement for the interface part of each sub-matrix Bᵢ.

In block 206, a global interface matrix is formed by local Schur complements on diagonal blocks and connections between sub-matrices on off-diagonal blocks (see Equation (4)). By construction, the resulting matrix has a block structure. It should be recognized that in certain embodiments the global interface matrix is not formed explicitly in block 206 (which may be quite an expensive operation), but instead each of a plurality of processing units employed for the parallel processing may store its respective part of the interface matrix. In this way, the global interface matrix may be formed implicitly, rather than explicitly, in certain embodiments.

All of blocks 202-206 are repeatedly applied starting with repartitioning of the interface matrix (in block 208) until the interface matrix is small enough. The term “small enough” in this embodiment is understood in the following sense. There are two parameters of the method which restrict applying a multi-level algorithm: 1) max levels determines the maximally allowed number of levels, and 2) min size is a threshold that determines the minimally allowed size in terms of number of rows of the interface matrix relative to the size of the original matrix. According to this embodiment, when either the recursion level reaches the maximal allowed number of levels or the size of the interface matrix becomes less then the min size multiplied by the size of the original matrix, the recursive process is stopped and the lowest level preconditioning is performed.

Thus, in block 207, a determination is made whether the interface matrix is “small enough.” If determined that it is not “small enough,” then operation advances to block 208 to repartition the interface matrix (as the original matrix was partitioned in block 201) and repeat processing of the repartitioned interface matrix in blocks 202-206. The repartitioning in block 208 is important in order to minimize the number of connection between the sub-matrices. When determined in block 207 that the dimension of the interface matrix is “small enough,” it may be factorized, in block 209, either directly or using iterative parallel (e.g. Block-Jacoby) method.

That method utilizing a multilevel approach can be applied as a preconditioner in iterative solvers. In addition, specific local scaling and local reordering algorithms can be applied in order to improve the quality of the preconditioner. The algorithm is applicable for both shared memory and distributed memory parallel architectures.

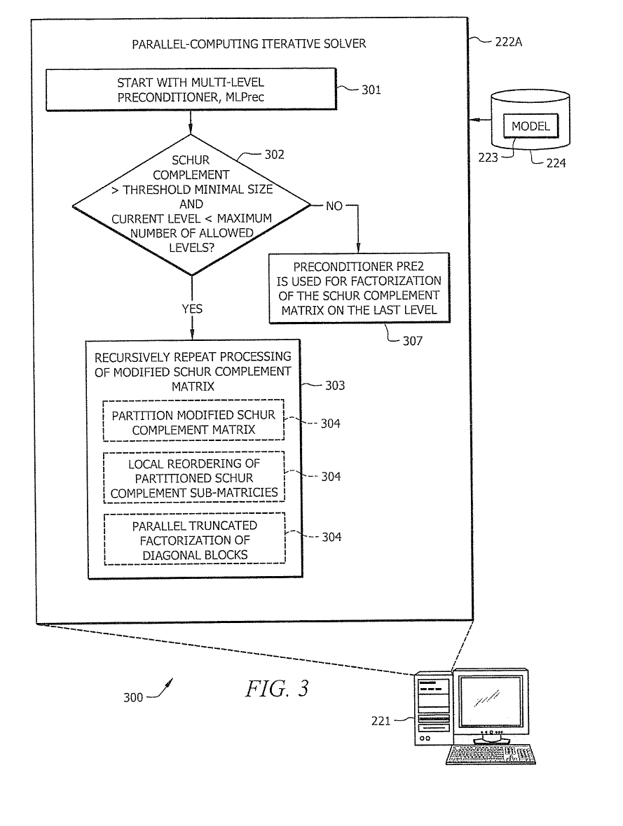

FIG. 3 shows another block diagram of an exemplary computer-based system 300 according to one embodiment of the present invention. As discussed above with FIG. 2, system 300 again comprises a processor-based computer 221, on which an exemplary embodiment of a parallel iterative solver, shown as parallel iterative solver 222A in FIG. 3, is executing to perform the operations discussed hereafter. According to this embodiment, a multi-level approach is utilized by parallel iterative solver 22A, as discussed hereafter with blocks 301-307.

Traditionally, the multi-level preconditioner MLPrec includes the following parameters: MLPrec(l,A,Prec1,Prec2, lₘₐₓ,τ), where l is a current level number, A is a matrix which has to be factorized, Prec1 is a preconditioner for factorization of independent submatrices Aᵢᵢ=LᵢUᵢ, Prec2 is a preconditioner for factorization of Schur complement S on the last level, lₘₐₓ is a maximal number of levels allowed, and τ is a threshold used to define minimal allowed size of S relatively to the size of A.

In operation of this exemplary embodiment, the parallel iterative solver starts, in block 301, with MLPrec(0, A, Prec1, Prec2, lₘₐₓ, τ). In block 302, the iterative solver determines whether |S|>τ·|A| and l<lₘₐₓ. When determined in block 302 that |S|>τ·|A| and l<lₘₐₓ, then the above-described parallel method (of FIG. 2) is recursively repeated for a modified Schur complement matrix S′: ML Prec(l+1,S′,Prec1,Prec2,lₘₐₓ,τ), in block 303. For instance, such recursively repeated operation may include partitioning the modified Schur complement matrix in sub-block 304 (as in block 208 of FIG. 2), local reordering of the partitioned Schur complement sub-matrices in sub-block 305 (as in block 202 of FIG. 2), and performing parallel truncated factorization of diagonal blocks in sub-block 306 (as in block 205 of FIG. 2). Thus, in one embodiment, the modified matrix S' is obtained from the matrix S after application of some partitioner (e.g., in block 208 of FIG. 2), which tries to minimize the number of connections in S. This partitioner can be the same as that one used for initial matrix partitioning on the first level (i.e., in block 201 of FIG. 2), or the partitioner may, in certain implementations be different.

When determined in block 302 that |s|<τ·|A| or l>lₘₐₓ, then the preconditioner Prec2 is used in block 307 for factorization of the Schur complement matrix Sᵢ on the last level. As discussed further herein, either serial high quality ILU preconditioner for very small Sᵢ or parallel block Jacoby preconditioner with ILU factorization of diagonal blocks may be used, as examples.

To improve the quality of the preconditioner, certain embodiments also use two additional local preprocessing techniques. The first one is the local scaling of matrices A₁₁ through Aₚₚ. And, the second technique is special local reordering which moves interface rows last and then orders interior rows in a graph multi-level manner minimizing profile of reordered diagonal block Aᵢᵢ=QᵢAᵢᵢQᵢ^{T}.

In addition to local reordering, a local scaling algorithm may also be executed in certain embodiments to improve numerical properties of sub-matrices and, hence, to improve the quality of independent truncated factorization. Further, local reordering is not required for all embodiments, but is instead an option that may be implemented for an embodiment of the algorithm. Local reordering may comprise not only simple reordering to move interior nodes first and interface nodes last in given natural order, but also can be a more complicated algorithm such as a graph multi-level manner minimizing profile of reordered diagonal block, mentioned above.

Thus, according to certain embodiments of the present invention, a parallel iterative solver uses a multi-level methodology based on the domain decomposition approach for transformation of an initial matrix to 2 by 2 block form. Further, in certain embodiments, the parallel iterative solver uses truncated variant of ILU-type factorization of local diagonal blocks to obtain the global Schur complement matrix as a sum of local Schur complement matrices. And, in certain embodiments, before repeating the multi-level procedure for the obtained global Schur complement matrix, the parallel iterative solver repartitions the obtained global Schur complement matrix in order to minimize the number of connections in the partitioned matrix. At the last level of the multi-level methodology, the parallel iterative solver, in certain embodiments, uses either serial ILU preconditioner or parallel block Jacobi preconditioner. In addition, in certain embodiments, the parallel iterative solver applies local scaling and special variant of matrix profile reducing local reordering.

One illustrative embodiment of a parallel iterative solver is explained further below for an exemplary case of parallel solution on distributed memory architecture with several separate processors. Embodiments may likewise be applied to shared-memory and hybrid-type architectures. An algorithm that may be employed for shared-memory architecture (SMP) as well as for hybrid architecture is very similar to the exemplary algorithm described for the below illustrative embodiment, except for certain implementation details that will be readily recognized by those of ordinary skill in the art (which are explained separately below, where applicable).

The parallel multi-level preconditioner of this illustrative embodiment is based on incomplete factorizations, and is referred to below as PMLILU for brevity.

Preconditioner construction. In this illustrative embodiment, the PMLILU preconditioner is based on non-overlapping form of the domain decomposition approach. Domain decomposition approach assumes that the solution of the entire problem can be obtained from solutions of sub-problems decomposed in some way with specific procedures of the solution aggregation on interfaces between sub-problems.

A graph G_{A} of sparsity structure of original matrix A is partitioned into the given number p of non-overlapped sub-graphs Gᵢ, such that

$${G}_{A} = {{⋃}^{p}}_{i} {G}_{i} , {G}_{k} ⋂ {G}_{m} = \text{:} k \neq m .$$

Such a partitioning corresponds to a row-wise partitioning of A into p sub-matrices:

$$A = ( \begin{matrix}{A}_{{1}^{*}} \\ {A}_{{2}^{*}} \\ ⋮ \\ {A}_{{p}^{*}}\end{matrix} ) ,$$

where A_{i*} are row strips that can be represented in a block form as follows: A_{i*}=(Aᵢᵢ . . . Aᵢᵢ . . . Aᵢₚ). The partitioning into row strips corresponds to the distribution of the matrix among processing units. It is noted that vectors are distributed in the same way, i.e. those elements of the vector corresponding to the elements of sub-graph Gᵢ are stored in the same processing units where rows trips A_{i*} are stored, in this illustrative embodiment.

Below, such a partitioning is denoted as {Aₚ^{l},p}, where l is the level number (sometimes it might be omitted for simplicity) and p is the number of parts. The size of the i-th part (the number of rows) is denoted as Nᵢ while the offset of the part from the first row (in terms of rows)—as Oᵢ. Thus,

$${O}_{i} = {\sum }_{k = l}^{i - 1} {N}_{k} .$$

The general block form of matrix partitioning can be written as

$$A = [ \begin{matrix}{A}_{11} & {A}_{12} & … & {A}_{1 P} \\ {A}_{21} & {A}_{22} & … & {A}_{2 P} \\ … & … & … & … \\ {A}_{p 1} & {A}_{p 2} & … & {A}_{pp}\end{matrix} ] .$$

In the below discussion, the matrix notations is used for simplicity. The term matrix row is usually used instead of the more traditional term “graph node,” although both terms can be applied interchangeably in the below discussion. Thus, graph nodes correspond to matrix rows, while graph edges correspond to matrix off-diagonal nonzero entries, which are connections between rows. The notation kεA_{i*} means that the k-th matrix row belongs to the i-th row strip. A standard graph notation mεadj(k) is used to say that aₖₘ≠0, which means that there exists connection between the k-th and the m-th matrix rows. The term part corresponds to the term row strip, in the below discussion. The term block is used to define a part of a row strip corresponding to a partitioning. In particular, Aᵢᵢ corresponds to the diagonal block which is Aᵢᵢ=A_{i*}[1: Nᵢ, Oᵢ: O_{i+1].}

In general, the main steps of the preconditioner construction algorithm, according to this illustrative embodiment, may be formulated as follows:

1. Matrix is partitioned (either in serial or in parallel) into given number of parts p (as in block 201 of FIG. 2). After such partitioning, the matrix is distributed among processors as row strips.

2. After partitioning, the rows of A_{i*} are divided into two groups: 1) the interior rows, i.e. the rows which have no connections with rows from other parts, and 2) interface (boundary) rows, which have connections with other parts. Local reordering is applied (as in block 202 of FIG. 2) to each strip to move interior rows first and interface nodes last. The reordering is applied independently to each strip (in parallel).

3. Parallel truncated factorization of diagonal blocks is computed with calculation of Schur complement for the corresponding interface diagonal block (as in block 205 of FIG. 2).

4. The interface matrix is formed (as in block 206 of FIG. 2). In this illustrative embodiment, the interface matrix comprises Schur complements of interface diagonal matrices and off-diagonal connection matrices.
a. If the size of the interface matrix is determined (e.g., in block 207 of FIG. 2) as “small enough” or the maximal allowed number of levels is reached, then the interface matrix is factorized (e.g., as in block 209 of FIG. 2).
b. Otherwise, the same algorithm discussed in steps 1-4 above is applied to the interface matrix in the same way as to the initial matrix. It is noted that at the step 1 of the construction procedure, the interface matrix should be partitioned again in order to minimize the number of connections between the parts (e.g., the interface matrix is partitioned in block 208 of FIG. 2, and then operation repeats blocks 202-207 of FIG. 2 for processing that partitioned interface matrix).

The factorization of the interface matrix on the lowest (last) level can be performed either in serial as full IL U-factorization of the interface matrix (this is more robust variant) or in parallel using iterative Relaxed Block Jacoby method with IL U-factorization of diagonal blocks. Thus, in certain embodiments, some serial work is allowed for relatively small interface matrix, but an advantage of that is a stable number of iterations is achieved for an increasing number of parts.

It is noted that the entire parallel solution process may start with an initial matrix partitioning (e.g., in block 201 of FIG. 2), which is used by any algorithm (such as preconditioner, iterative method, and so on). Hence, the initial partitioning (of block 201 of FIG. 2) is an external operation with respect to the preconditioner. Thus, PMLILU of this illustrative embodiment has a partitioned (and distributed) matrix as an input parameter.

This is illustrated by the following exemplary pseudocode of Algorithm 1 (for preconditioner construction):

Given a matrix A, a right hand side vector b, a vector of unknowns x, a number of parts p
{Aₚ⁰,p}=Partitioner_{EXT}(A,p);//apply an external partitioning PMLILU(0,{Aₚ⁰,p});//call parallel multi-level ILU.

The parallel multi-level ILU algorithm (PMLILU) may be written, in this illustrative embodiment, according to the following exemplary pseudocode of Algorithm 2:

```
Defined algorithms:
Truncated_ILU, Last_level_Prec, Local_Reordering,
Local_Scaling, Partitioner_{IM} (interface matrix partitioner)
Parameters: max_levels, min_size_prc
PMLILU.Construct(level, {Aₚ, P})
{
  // Local reordering
  in_parallel i=1:p {
      Local_Reordering(i);
  }
  // Local scaling
  if is_defined(Local_Scaling) then
      in_parallel i=1:p {
          Local_Scaling(i);
      }
  endif
  // Parallel truncated factorization
  in_parallel i=1:p {
      Truncated_ILU(i);
  }
  // Form (implicitly) the interface matrix
  A^{B}=form_im( );
  // Run either recursion or last level factorization
  if level < max_levels and size (A^{B}) > min_size then
      PMLILU.Construct(level+1, Partitioner_{IM}(A^{B}));
  else
      Last_level_Prec(A^{B});
  endif
}
```

It is noted that Algorithm 2 above is defined for any type of basic algorithms used by PMLILU, such as Truncated_ILU, Last_level_Prec, Local_Scaling, Local_Reordering, Partitioner. One can choose any appropriate algorithm and use it inside of PMLILU.

Below, the steps of the algorithm construction according to this illustrative embodiment are considered, and implementation details related to the considered steps are discussed further for this illustrative embodiment.

Matrix partitioning. As mentioned above, the initial partitioning and distribution of the system is performed outside of the preconditioner construction algorithm as follows:

// Apply an external partitioning
{Aₚ⁰p} = Partitioner_{EXT} (A, p);
for all i = 1:p do

send (A_{i*}, b_{i*}, x_{i*}⁰, Procᵢ);

endfor

$A = [ \begin{matrix}{A}_{11} & {A}_{12} & … & {A}_{1 P} \\ {A}_{21} & {A}_{22} & … & {A}_{2 p} \\ … & … & … & … \\ {A}_{p 1} & {A}_{p 2} & … & {A}_{pp}\end{matrix} ] \begin{matrix}⇒ \\ ⇒ \\ \\ ⇒\end{matrix} \begin{matrix}{Proc}_{1} \\ {Proc}_{2} \\ … \\ {Proc}_{p}\end{matrix}$

For the initial partitioning (“IPT”), the high-quality multi-level approach may be used, which is similar to that from the well-known software package METIS (as described in G. Karypis and V. Kumar, METIS: Unstructured Graph Partitioning and Sparse Matrix Ordering System, Version 4.0, September 1998, the disclosure of which is hereby incorporated herein by reference). The interface matrix partitioning is discussed further below.

It is noted also that usually any partitioner permutes the original matrix. Depending on basic algorithm and quality constrains, the partitioned matrix can be written as Â=P_{IPT}AP_{IPT}^{T}. Thus, Algorithm 2 discussed above obtains permuted, partitioned, and distributed matrix at input.

For SMP architecture, it may also be advantageous to store row strips A_{i*} in the distributed-like data structure, which allows noticeable decrease in the cost of memory access. For that, A_{i*} should be allocated in parallel, which then allows any thread to use the matrix part optimally located in memory banks. On those shared-memory architectures which allow binding a particular thread to a certain processing units, the binding procedure may provide additional gain in performance.

Local reordering. After partitioning, the rows of a row strip A_{i*} have to be divided into two subsets:

1) a set of the interior rows A_{i*}^{I}, which are the rows that have no connections with rows from other parts: {kεA_{i*}^{U}: ∀mεadj(k),mεA_{i*}}, and

2) a set of the interface (boundary) rows, which have connections with rows from other parts: {kεA_{i*}^{B}: ∃mεadj(k),mεA_{j*},j≠i}.

Local reordering is applied to enumerate first, the interior rows, then the interface rows:

$${P}_{i} {A}_{ii} {P}_{i}^{T} = ( \begin{matrix}{A}_{ii}^{I} & {B}_{ii}^{IB} \\ {A}_{ii}^{BI} & {A}_{ii}^{B}\end{matrix} ) = ( \begin{matrix}{A}_{i} & {F}_{i} \\ {C}_{i} & {B}_{i}\end{matrix} ) .$$

Due to locality of this operation, it is performed in parallel in this illustrative embodiment. After local permutation of the diagonal block, all local permutation vectors from adjacent processors are gathered to permute off-diagonal matrices Aᵢ (in case if Aij≠0). The general framework of the local reordering algorithm of this illustrative embodiment may be written in pseudocode as follows (referred to as Algorithm 3):

// Local reordering
in_parallel i=1:p {

| | |
|---|---|
| Aᵢᵢ =diag(Aᵢ*); | // extract diagonal block |
| Aᵢᵢ =PᵢAᵢᵢPᵢ; | // compute and apply local permutation vector Pᵢ |
| P=gather(Pⱼ); | // gather full permutation vector P |
| Aᵢ^{R} = PᵢAᵢP^{T} ; | // permute the off-diagonal part of the i-th row strip |
| } | |

It is possible to use various algorithms of the local reordering, but for simplicity a natural ordering is used, such as in the following exemplary pseudocode of this illustrative embodiment (referred to as Algorithm 4):

```
// 1. Traverse the row strip computing permutation for internal nodes
//  and marking interface ones
n_interior = 0; mask[1:Nᵢ] = 0;
for k=Oᵢ:Oᵢ₊₁−1 do
  if ∃m ε adj(k) : m ∉ Aᵢ* then
      mask[k] = 1;
  else
      n_interior = n_interior + 1;
      perm[n_interior] = k;
  endif
endfor
// 2. Complete permutation with interface nodes
p = n_interior;
for k=Oᵢ:Oᵢ₊₁−1 do
  if mask[k] == 1 then
      perm[p] = k;
      p = p + 1;
  endif
endfor
```

Thus, after applying of the local permutation the matrix can be written as follows:

$$[ \begin{matrix}{A}_{1} & {F}_{1} & & & & & \\ {C}_{1} & {B}_{1} & & {A}_{12} & … & & {A}_{1 p} \\ & & {A}_{2} & {F}_{2} & … & & \\ & {A}_{21} & {C}_{2} & {B}_{2} & & & {A}_{2 p} \\ & … & & … & … & & … \\ & & & & & {A}_{p} & {F}_{p} \\ & {A}_{p 1} & & {A}_{p 2} & … & {C}_{p} & {B}_{p}\end{matrix} ]$$

Rearranging all interface (boundary) blocks Bᵢ and Aᵢⱼ, to the end of the matrix the block bordered diagonal form (BBD) of a matrix splitting is obtained:

$$[ \begin{matrix}{A}_{1} & & & & {F}_{1} & & & \\ & {A}_{2} & & & & {F}_{2} & & \\ & & … & & & & … & \\ & & & {A}_{p} & & & & {F}_{p} \\ {C}_{1} & & & & {B}_{1} & {A}_{12} & … & {A}_{1 p} \\ & {C}_{2} & & & {A}_{21} & {B}_{2} & … & {A}_{2 p} \\ & & … & & … & … & … & … \\ & & & {C}_{p} & {A}_{p 1} & {A}_{p 2} & … & {B}_{p}\end{matrix} ] ,$$

where the matrix in the right lower corner is the interface matrix which assembles all connections between parts of the matrix:

$$( \begin{matrix}{B}_{1} & {A}_{12} & … & {A}_{1 p} \\ {A}_{21} & {B}_{2} & … & {A}_{2 p} \\ … & … & … & … \\ {A}_{p 1} & {A}_{p 2} & … & {B}_{p}\end{matrix} ) .$$

Processing of the interface matrix, according to this illustrative embodiment, is discussed further below.

Local scaling. A scaling can significantly improve the quality of the preconditioner and, as result, overall performance of the iterative solver. It is especially true for matrices arisen from discretization of partial differential equations (PDEs) with several unknowns (degrees of freedom) per one grid cell. In general, applying some considerations, the scaling algorithm computes two diagonal matrices D^{L} and D^{R}, which improve some matrix scaling properties (for example, equalizing magnitudes of diagonal entries or row/column norms) that usually leads to more stable factorization. Application of a global scaling may lead to some additional expenses in communications between processing units, while application of a local scaling to the diagonal matrix of a part will require only partial gathering of column scaling matrix D^{R} without significant losses in quality.

It is noted that, in this illustrative embodiment, the scaling is applied to the whole diagonal block of a part: Âᵢᵢ=Dᵢ^{L}AᵢᵢDᵢ^{R}.

The local scaling algorithm can be written as follows:

in_parallel i=1:p {

| | |
|---|---|
| [Dᵢ^{L},Dᵢ^{R}]=Local_Scaling(Aᵢᵢ); | // compute local scaling matrices |
| | Dᵢ^{L},Dᵢ^{R} |
| D^{C}=gather(Dⱼ^{C}); | // gather full column scaling matrix D^{R} |
| Aᵢ^{SR}=Dᵢ^{R}AᵢⱼDⱼ^{C}; | // scale the i-th part |
| } | |

Parallel truncated factorization. The next step of the algorithm, in this illustrative embodiment, is the parallel truncated factorization of diagonal blocks with calculation of Schur complement for the corresponding interface diagonal block:

// Parallel truncated factorization
in_parallel i=1:p {
Lᵢ^{l}Uᵢ^{l} = Truncated_ILU(Aᵢᵢ^{SR}); // truncated factorization
}

The truncated (restricted) variant of ILU factorization is intended to compute incomplete factors and approximate Schur complement and can be implemented similar to that described in Y. Saad, Iterative Methods for Sparse Linear Systems, 2nd ed, SIAM, Philadelphia, 2003, the disclosure of which is incorporated herein by reference.

Thus, factorized diagonal block will have the following structure:

$$( \begin{matrix}{A}_{i} & {F}_{i} \\ {C}_{i} & B\end{matrix} ) \approx ( \begin{matrix}L & 0 \\ {C}_{i} {U}_{i}^{- 1} & {I}_{i}\end{matrix} ) \times ( \begin{matrix}{U}_{i} & {L}_{i}^{- 1} , {F}_{i} \\ 0 & {S}_{i}\end{matrix} ) = ( \begin{matrix}{L}_{i} & 0 \\ {L}_{i}^{C} & {I}_{i}\end{matrix} ) \times ( \begin{matrix}{U}_{i} & {U}_{i}^{F} \\ 0 & {S}_{i}\end{matrix} ) = {\hat{L}}_{i} {\hat{U}}_{i}$$

$${S}_{i} = {B}_{i} - {{C}_{i} ( {L}_{i} {U}_{i} )}^{- 1} {F}_{i}$$

Interface matrix processing. The last step of the algorithm in this illustrative embodiment is the interface matrix processing. After performing the parallel truncated factorization described above, the interface matrix can be written as follows:

$${S}_{L} = ( \begin{matrix}{S}_{1} & {A}_{12} & … & {A}_{1 p} \\ {A}_{21} & {S}_{2} & … & {A}_{2 p} \\ … & … & … & … \\ {A}_{p 1} & {A}_{p 2} & … & {S}_{p}\end{matrix} ) ,$$

where Sᵢ is a Schur complement of the i-th interface matrix. Now the size (number of rows) of the matrix is checked, and if it is small enough, then the last-level factorization is applied; otherwise, the entire procedure for repartitioned is repeated recursively, such as in the following exemplary pseudocode:

```
// Form (implicitly) the interface matrix
Aₚ^{B} = join(Aᵢ^{B});
// Run either PMLILU recursively or the last-level factorization
if level < max_levels and size(Aₚ^{B}) > min_size then
  PMLILU.Construct(level+l, Part_{IM}(Aₚ^{B}));
else
  last_level = level;
  M_{L}=Last_level_Prec(Aₚ^{B}); // last-level full factorization
endif
```

It is noted that, in general, it is not necessary, according to this illustrative embodiment, to form this matrix explicitly except in two cases:

1. if a serial partitioning is used for the interface matrix partitioning, then it is performed to assemble its graph; and

2. if a serial preconditioning is defined for the last level factorization, then it is performed to assemble it as a whole.

In general, the interface matrix partitioner, Partitionerᵢ, can be different from the initial partitioner (such as that used in block 201 of FIG. 2). If a sequence of linear algebraic problems is solved with matrices of the same structure, like in modeling time-dependent problems, the initial partitioner can be serial and may be used only a few times (or even once) during the entire multi-time step simulation. At the same time, Partitioner_{IM} should be parallel to avoid interface matrix graph gathering for serial partitioning (although this variant is also possible and may be employed in certain implementations).

There are two main variants of the last level factorization that may be employed in accordance with this illustrative embodiment:

1. Pure serial ILU; and

2. Iterative Relaxed Block-Jacoby with ILU in diagonal blocks (IRBJILU).

Thus, according to certain embodiments, the algorithm advantageously uses parallel multi-level partitioning of the interface matrix to avoid explicit forming of the interface matrix on the master processing unit, as is required in the case of serial multi-level partitioning. In processing the last level of the interface matrix, the corresponding interface matrix may be factorized either serially or in parallel by applying of predefined preconditioner. Possible variants that may be employed for such processing of the last level of the interface matrix include: serial high-quality ILU factorization or parallel iterative relaxed Block-Jacoby preconditioner with high-quality ILU factorization of diagonal blocks, as examples.

In most of numerical experiments, the first variant (i.e., pure serial ILU) produces better overall performance of the parallel iterative solver, keeping almost the same number of iterations required for the convergence as that of the corresponding serial variant; while the second variant (i.e., IRBJILU) degrades the convergence when the number of parts increases.

Now, we consider what preconditioner data each processing unit may store in accordance with this illustrative embodiment. For each level 1, the i-th processor stores Lᵢ^{l},L.ᵢ^{Cl},Uᵢ^{IM},Uᵢ^{Fl},Pᵢ^{IM}, where Pᵢ^{IM} is some aggregate information from the interface matrix partitioner needed for the i-th processor (permutation vector, partitioning arrays, and in some instances something more). Additionally, the master processor stores the preconditioning matrix Mi of the last level factorization. It is noted that it is not necessary, in this illustrative embodiment, to keep the interface matrices after they were used in the factorization procedure.

Parallel preconditioner solution. On each iteration of the iterative method of this illustrative embodiment, the linear algebraic problem with preconditioner obtained by ILU-type factorization is solved. By construction, the preconditioner is represented in this illustrative embodiment as a product of lower and upper triangular matrices; and so, the solution procedure can be defined as the forward and backward substitution:

LUt=s

Lw=s;Ut=w

For the proposed method to be efficient in this illustrative embodiment, it is desirable to develop the effective parallel formulation of this procedure. In the below discussion, the forward substitution, which is actually the lower triangular solve, is denoted as L solve, and the backward substitution is denoted as U solve.

The parallel formulation of the triangular solvers exploits the multi-level structure of L, U factors generated by the factorization procedure. It implements parallel variant of the multi-level solution approach. Let the vectors t, s and w be split according to initial partitioning:

$$t = ( \begin{matrix}{t}_{1} \\ {t}_{2} \\ … \\ {t}_{p}\end{matrix} ) , s = ( \begin{matrix}{s}_{1} \\ {s}_{2} \\ … \\ {s}_{p}\end{matrix} ) , w = ( \begin{matrix}{w}_{1} \\ {w}_{2} \\ … \\ {w}_{p}\end{matrix} ) ,$$

where each part tᵢ, sᵢ, and wᵢ is split into the interior and interface sub-parts:

$${t}_{i} = ( \begin{matrix}{t}_{i}^{I} \\ {t}_{i}^{B}\end{matrix} ) = ( \begin{matrix}{x}_{i} \\ {y}_{i}\end{matrix} ) , {s}_{i} = ( \begin{matrix}{s}_{i}^{I} \\ {s}_{i}^{B}\end{matrix} ) = ( \begin{matrix}{r}_{i} \\ {q}_{i}\end{matrix} ) , {w}_{i} = ( \begin{matrix}{w}_{i}^{I} \\ {w}_{i}^{B}\end{matrix} ) = ( \begin{matrix}{u}_{i} \\ {v}_{i}\end{matrix} ) .$$

It should be recalled that the factorization of the i-th block has the following structure:

$${A}_{ii} \approx ( \begin{matrix}{L}_{i} & 0 \\ {L}_{i}^{C} & I\end{matrix} ) \times ( \begin{matrix}{U}_{i} & {U}_{i}^{F} \\ 0 & {S}_{i}\end{matrix} ) = {\hat{L}}_{i} {\hat{U}}_{i} .$$

Then, according to this illustrative embodiment, the algorithm of the preconditioner solution procedure can be written as follows:

```
Given from PMLILU.Construct( ): ML structure of L, U factors,
last_level
PMLILU.Solve( level, t, s)
{
  // Forward substitution (triangular L-solve)
  in_parallel i=1:p {
      Lᵢuᵢ = rᵢ;
      qᵢ = qᵢ − Lᵢ^{C}uᵢ;
  }
  // Now we have the right-hand side vector q={q₁,q₂,...,qₚ}^{T}
  // for the solution of the interface matrix
  if level==last_level then
      M_{L}y=q;
  else
      PMLILU.Solve(level+1,Partitioner_{IM}(v),Partitioner_{IM}(q));
  endif
  // Backward substitution (triangular U-solve)
  for l=last_level−1:1 do {
      v = invPartitioner_{IM}(v);
      in_parallel {
          Uᵢxᵢ = uᵢ − Uᵢ^{F} yᵢ
      }
  }
}
```

Thus, according to this illustrative embodiment, the solution procedure comprises:

1. serial LU solve in the last level of the multi-level approach;

2. application of the internal partitioner to vectors v, q that implies some data exchange between processors used in the parallel processing; and

3. application of the inverse internal partitioner to restore initial distribution of the vector v among the processors used in the parallel processing.

Example for P=4 and L=2. For further illustrative purposes, consider an example for the number of parts equal to 4, the number of levels equal to 2 and LU-type factorization on the last level. According to this illustrative embodiment, the construction procedure is performed as discussed below.

1) Level 1. After an external initial partitioning into 4 parts, the system will have the following form:

$$( \begin{matrix}{A}_{11}^{1} & {A}_{12}^{1} & {A}_{13}^{1} & {A}_{14}^{1} \\ {A}_{21}^{1} & {A}_{22}^{1} & {A}_{23}^{1} & {A}_{24}^{1} \\ {A}_{31}^{1} & {A}_{32}^{1} & {A}_{33}^{1} & {A}_{34}^{1} \\ {A}_{41}^{1} & {A}_{42}^{1} & {A}_{43}^{1} & {A}_{44}^{1}\end{matrix} ) ( \begin{matrix}{x}_{1}^{1} \\ {x}_{2}^{1} \\ {x}_{3}^{1} \\ {x}_{4}^{1}\end{matrix} ) = ( \begin{matrix}{b}_{1}^{1} \\ {b}_{2}^{1} \\ {b}_{3}^{1} \\ {b}_{4}^{1}\end{matrix} ) ,$$

where an upper index 1 means the level number.

Applying the local reordering and transforming to the block bordered diagonal (BBD) form leads to the following structure:

$$( \begin{matrix}{A}_{1}^{1} & & & & {F}_{1}^{1} & & & \\ & {A}_{2}^{1} & & & & {F}_{2}^{1} & & \\ & & {A}_{3}^{1} & & & & {F}_{3}^{1} & \\ & & & {A}_{4}^{1} & & & & {F}_{4}^{1} \\ {C}_{1}^{1} & & & & {B}_{1}^{1} & {A}_{12}^{1} & {A}_{13}^{1} & {A}_{14}^{1} \\ & {C}_{2}^{1} & & & {A}_{21}^{1} & {B}_{2}^{1} & {A}_{23}^{1} & {A}_{24}^{1} \\ & & {C}_{3}^{1} & & {A}_{31}^{1} & {A}_{32}^{1} & {B}_{3}^{1} & {A}_{34}^{1} \\ & & & {C}_{4}^{1} & {A}_{41}^{1} & {A}_{42}^{1} & {A}_{43}^{1} & {B}_{4}^{1}\end{matrix} ) .$$

Applying the parallel truncated factorization to diagonal blocks induces the following LU factorization:

$$( \begin{matrix}{L}_{1}^{1} & & & & & & & \\ & {L}_{2}^{1} & & & & & & \\ & & {L}_{3}^{1} & & & & & \\ & & & {L}_{4}^{1} & & & & \\ {L}_{1}^{C 1} & & & & {I}_{1} & & & \\ & {L}_{2}^{C 1} & & & & {I}_{2}^{1} & & \\ & & {L}_{3}^{C 1} & & & & {I}_{3}^{1} & \\ & & & {L}_{4}^{C 1} & & & & {I}_{4}^{1}\end{matrix} ) \times ( \begin{matrix}{U}_{1}^{1} & & & & {U}_{1}^{F 1} & & & \\ & {U}_{2}^{1} & & & & {U}_{2}^{F 1} & & \\ & & {U}_{3}^{1} & & & & {U}_{3}^{F 1} & \\ & & & {U}_{4}^{1} & & & & {U}_{4}^{F 1} \\ & & & & {S}_{1}^{1} & {A}_{12}^{1} & {A}_{13}^{1} & {A}_{14}^{1} \\ & & & & {A}_{21}^{1} & {S}_{2}^{1} & {A}_{23}^{1} & {A}_{34}^{1} \\ & & & & {A}_{31}^{1} & {A}_{32}^{1} & {S}_{3}^{1} & {A}_{34}^{1} \\ & & & & {A}_{41}^{1} & {A}_{42}^{1} & {A}_{43}^{1} & {S}_{4}^{1}\end{matrix} ) .$$

Suppose that a size of the interface matrix is determined as being big enough (as in block 207 of FIG. 2), the process proceeds to level 2, which is discussed below.

2) Level 2. At first, the first level interface matrix is re-partitioned, as follows:

$${S}^{1} = ( \begin{matrix}{S}_{1}^{1} & {A}_{12}^{1} & {A}_{13}^{1} & {A}_{14}^{1} \\ {A}_{21}^{1} & {S}_{2}^{1} & {A}_{23}^{1} & {A}_{24}^{1} \\ {A}_{31}^{1} & {A}_{32}^{1} & {S}_{3}^{1} & {A}_{34}^{1} \\ {A}_{41}^{1} & {A}_{42}^{1} & {A}_{43}^{1} & {S}_{4}^{1}\end{matrix} ) by {Partitioner}_{IM} .$$

It is noted that the whole matrix is repartitioned including Schur complements using either serial or parallel partitioning. For this reason, a parallel partitioner is implemented in this illustrative embodiment, wherein the parallel partitioner is able to construct a high-quality partitioning in parallel for each block row strip of the interface matrix.

After the repartitioning, the following matrix is obtained:

$${A}^{2} = ( \begin{matrix}{A}_{11}^{2} & {A}_{12}^{2} & {A}_{13}^{2} & {A}_{14}^{2} \\ {A}_{21}^{2} & {A}_{22}^{2} & {A}_{23}^{2} & {A}_{24}^{2} \\ {A}_{31}^{2} & {A}_{32}^{2} & {A}_{33}^{2} & {A}_{34}^{2} \\ {A}_{41}^{2} & {A}_{42}^{2} & {A}_{43}^{2} & {A}_{44}^{2}\end{matrix} ) ,$$

and the above-described procedures are applied for constructing Lᵢ²,Uᵢ²,Lᵢ^{C2},Uᵢ^{F2},Sᵢ² and obtain as result the second level interface matrix:

$${S}^{2} = ( \begin{matrix}{S}_{1}^{2} & {A}_{12}^{2} & {A}_{13}^{2} & {A}_{14}^{2} \\ {A}_{21}^{2} & {S}_{2}^{2} & {A}_{23}^{2} & {A}_{24}^{2} \\ {A}_{31}^{2} & {A}_{32}^{2} & {S}_{3}^{2} & {A}_{34}^{2} \\ {A}_{41}^{2} & {A}_{42}^{2} & {A}_{43}^{2} & {S}_{4}^{2}\end{matrix} ) .$$

As the maximal allowed number of levels is reached, the last level factorization is performed for the above interface matrix S²: S²=L_{LL}²U_{LL}². The maximal allowed number of levels is one of the parameters of the algorithm (see Algorithm 2) in this embodiment. Moreover, in that example maximal number of levels is set to 2.

Now, the initialization step has been finished, and the iterative solver continues with the solution procedure.

The L solve matrix in the 1st level can be written as follows:

$$( \begin{matrix}{L}_{1}^{1} & & & & & & & \\ & {L}_{2}^{1} & & & & & & \\ & & {L}_{3}^{1} & & & & & \\ & & & {L}_{4}^{1} & & & & \\ {L}_{1}^{C 1} & & & & {I}_{1} & & & \\ & {L}_{2}^{C 1} & & & & {I}_{2}^{1} & & \\ & & {L}_{3}^{C 1} & & & & {I}_{3}^{1} & \\ & & & {L}_{4}^{C 1} & & & & {I}_{4}^{1}\end{matrix} ) ( \begin{matrix}{u}_{1}^{1} \\ {u}_{2}^{1} \\ {u}_{3}^{1} \\ {u}_{4}^{1} \\ {v}_{1}^{1} \\ {v}_{2}^{1} \\ {v}_{3}^{1} \\ {v}_{4}^{1}\end{matrix} ) = ( \begin{matrix}{r}_{1}^{1} \\ {r}_{2}^{1} \\ {r}_{3}^{1} \\ {r}_{4}^{1} \\ {q}_{1}^{1} \\ {q}_{2}^{1} \\ {q}_{3}^{1} \\ {q}_{4}^{1}\end{matrix} ) .$$

Solving Lᵢ¹uᵢ¹=rᵢ¹ and substituting vᵢ¹=qᵢ¹−Lᵢ^{C1}uᵢ¹ in parallel, the right hand side vector is obtained as: v¹={v₁¹, v₂¹, v₃¹, v₄¹,}^{T} for the first level interface matrix S¹. Then, the iterative solver permutes and redistributes the vector v assigning s²=Part_{IM}(v¹), and repeats the above-described procedures: Lᵢ²uᵢ2=rᵢ² and vᵢ²=qᵢ²−Lᵢ^{C2}uᵢ² to perform L solve in the second level.

Then, the iterative solver performs a full solve in the last level: L_{LL}U_{LL}y²=v². After that, the iterative solver of this illustrative embodiment recursively performs U solve in the backward order starting with the second level.

Consider now the second level U solve of this illustrative embodiment in further detail. The solution obtained from the last level preconditioner solve y={y₁², y₂², y₃², y₄²}^{T} is used to modify the right hand side vector in parallel and then solve the system

$$( \begin{matrix}{U}_{1}^{2} & & & \\ & {U}_{2}^{2} & & \\ & & {U}_{3}^{2} & \\ & & & {U}_{4}^{2}\end{matrix} ) ( \begin{matrix}{t}_{1}^{2} \\ {t}_{2}^{2} \\ {t}_{3}^{2} \\ {t}_{4}^{2}\end{matrix} ) = ( \begin{matrix}{u}_{1}^{2} - {U}_{1}^{F 2} {y}_{1}^{2} \\ {u}_{2}^{2} - {U}_{2}^{F 2} {y}_{2}^{2} \\ {u}_{3}^{2} - {U}_{3}^{F 2} {y}_{3}^{2} \\ {u}_{4}^{2} - {U}_{4}^{F 2} {y}_{4}^{2}\end{matrix} ) .$$

Applying inverse permutation and redistribution y¹=invPart_{IM}(t²) the iterative solver can apply the above-described algorithm to perform Usolve on the first level:

$$( \begin{matrix}{U}_{1}^{1} & & & \\ & {U}_{2}^{1} & & \\ & & {U}_{3}^{1} & \\ & & & {U}_{4}^{1}\end{matrix} ) ( \begin{matrix}{t}_{1}^{1} \\ {t}_{2}^{1} \\ {t}_{3}^{1} \\ {t}_{4}^{1}\end{matrix} ) = ( \begin{matrix}{u}_{1}^{1} - {U}_{1}^{F 1} {y}_{1}^{1} \\ {u}_{2}^{1} - {U}_{2}^{F 1} {y}_{2}^{1} \\ {u}_{3}^{1} - {U}_{3}^{F 1} {y}_{3}^{1} \\ {u}_{4}^{1} - {U}_{4}^{F 1} {y}_{4}^{1}\end{matrix} ) .$$

Thus, the above illustrative embodiment employs an approach to the parallel solution of large sparse linear systems, which implements the factorization scheme with high degree of parallelization. The optimal variant allows some very small serial work which may take less than 1% of the overall work, but allows obtaining the parallel preconditioner with almost the same quality as the corresponding serial one in terms of the number of iterations of the iterative solver required for convergence. Moreover, applying pure parallel local reordering and scaling may significantly improve the quality of preconditioner.

Embodiments, or portions thereof, may be embodied in program or code segments operable upon a processor-based system (e.g., computer system) for performing functions and operations as described herein for the parallel-computing iterative solver. The program or code segments making up the various embodiments may be stored in a computer-readable medium, which may comprise any suitable medium for temporarily or permanently storing such code. Examples of the computer-readable medium include such physical computer-readable media as an electronic memory circuit, a semiconductor memory device, random access memory (RAM), read only memory (ROM), erasable ROM (EROM), flash memory, a magnetic storage device (e.g., floppy diskette), optical storage device (e.g., compact disk (CD), digital versatile disk (DVD), etc.), a hard disk, and the like.

FIG. 4 illustrates an exemplary computer system 400 on which software for performing processing operations of the above-described parallel-computing iterative solver according to embodiments of the present invention may be implemented. Central processing unit (CPU) 401 is coupled to system bus 402. While a single CPU 401 is illustrated, it should be recognized that computer system 400 preferably comprises a plurality of processing units (e.g., CPUs 401) to be employed in the above-described parallel computing. CPU(s) 401 may be any general-purpose CPU(s). The present invention is not restricted by the architecture of CPU(s) 401 (or other components of exemplary system 400) as long as CPU(s) 401 (and other components of system 400) supports the inventive operations as described herein. CPU(s) 401 may execute the various logical instructions according to embodiments described above. For example, CPU(s) 401 may execute machine-level instructions for performing processing according to the exemplary operational flows of embodiments of the parallel-computing iterative solver as described above in conjunction with FIGS. 2-3.

Computer system 400 also preferably includes random access memory (RAM) 403, which may be SRAM, DRAM, SDRAM, or the like. Computer system 400 preferably includes read-only memory (ROM) 404 which may be PROM, EPROM, EEPROM, or the like. RAM 403 and ROM 404 hold user and system data and programs, as is well known in the art.

Computer system 400 also preferably includes input/output (I/O) adapter 405, communications adapter 411, user interface adapter 408, and display adapter 409. I/O adapter 405, user interface adapter 408, and/or communications adapter 411 may, in certain embodiments, enable a user to interact with computer system 400 in order to input information.

I/O adapter 405 preferably connects to storage device(s) 406, such as one or more of hard drive, compact disc (CD) drive, floppy disk drive, tape drive, etc. to computer system 400. The storage devices may be utilized when RAM 403 is insufficient for the memory requirements associated with storing data for operations of embodiments of the present invention. The data storage of computer system 400 may be used for storing such information as a model (e.g., model 223 of FIGS. 2-3), intermediate and/or final results computed by the parallel-computing iterative solver, and/or other data used or generated in accordance with embodiments of the present invention. Communications adapter 411 is preferably adapted to couple computer system 400 to network 412, which may enable information to be input to and/or output from system 400 via such network 412 (e.g., the Internet or other wide-area network, a local-area network, a public or private switched telephony network, a wireless network, any combination of the foregoing). User interface adapter 408 couples user input devices, such as keyboard 413, pointing device 407, and microphone 414 and/or output devices, such as speaker(s) 415 to computer system 400. Display adapter 409 is driven by CPU(s) 401 to control the display on display device 410 to, for example, display information pertaining to a model under analysis, such as displaying a generated 3D representation of fluid flow in a subsurface hydrocarbon bearing reservoir over time, according to certain embodiments.

It shall be appreciated that the present invention is not limited to the architecture of system 400. For example, any suitable processor-based device may be utilized for implementing all or a portion of embodiments of the present invention, including without limitation personal computers, laptop computers, computer workstations, servers, and/or other multi-processor computing devices. Moreover, embodiments may be implemented on application specific integrated circuits (ASICs) or very large scale integrated (VLSI) circuits. In fact, persons of ordinary skill in the art may utilize any number of suitable structures capable of executing logical operations according to the embodiments.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method comprising:
(a) partitioning an original matrix into a plurality of sub-matrices using multi-level partitioning;
(b) performing, in parallel, truncated factorization of diagonal blocks with forming a local Schur complement for an interface part of each of the plurality of sub-matrices;
(c) forming a global interface matrix by local Schur complements on diagonal blocks of the plurality of sub-matrices and connections between the plurality of sub-matrices on off-diagonal blocks;
(d) determining at least one of: i) whether the global interface matrix is sufficiently small to satisfy a predefined size threshold, and ii) whether a last allowed level is reached; and
(e) when determined that the global interface matrix is not sufficiently small to satisfy said predefined size threshold or that the last allowed level is reached, partitioning the global interface matrix into a second plurality of sub-matrices using multi-level partitioning and repeating operations (b)-(e) for the second plurality of sub-matrices.

2. The method of claim 1 further comprising:
(f) when determined that the global interface matrix is sufficiently small to satisfy said predefined size threshold, factorizing the global interface matrix.

3. The method of claim 1 further comprising:
reordering each of the plurality of sub-matrices.

4. The method of claim 3 wherein said reordering is performed after operation (a) and before operation (b).

5. The method of claim 3 wherein the reordering comprises:
first reordering interior rows of each of the plurality of sub-matrices; and
then reordering interface rows of the plurality of sub-matrices.

6. The method of claim 1 further comprising:
performing a local scaling algorithm on the plurality of sub-matrices to improve numerical properties of the sub-matrices.

7. The method of claim 1 wherein said forming said global interface matrix comprises:
forming the global interface matrix implicitly.

8. The method of claim 7 wherein said forming said global interface matrix implicitly comprises:
storing, by each of a plurality of processing units, a corresponding part of the interface matrix.

9. The method of claim 1 wherein said performing, in parallel, comprises:
performing said operation (b) by a plurality of parallel processing units.

10. The method of claim 1 wherein said partitioning the global interface matrix into said second plurality of sub-matrices using multi-level partitioning comprises:
using multi-level partitioning of the interface matrix to avoid explicit forming of the interface matrix on a master processing unit.

11. The method of claim 1 further comprising:
processing of a last level interface matrix.

12. The method of claim 11 wherein said processing of the last level interface matrix comprises:
on the last level, the corresponding interface matrix is factorized by applying of predefined preconditioner.

13. The method of claim 12 wherein said corresponding interface matrix is factorized serially.

14. The method of claim 12 wherein said corresponding interface matrix is factorized in parallel.

15. The method of claim 11 wherein said processing of the last level interface matrix comprises:
on the last level, the corresponding interface matrix is factorized by applying serial high-quality ILU factorization.

16. The method of claim 11 wherein said processing of the last level interface matrix comprises:
on the last level, the corresponding interface matrix is factorized by applying parallel iterative relaxed Block-Jacoby preconditioner with high-quality ILU factorization of diagonal blocks.

17. A method comprising:
(a) partitioning an original matrix into a plurality of sub-matrices using multi-level partitioning;
(b) performing, in parallel, truncated factorization of diagonal blocks with forming a local Schur complement for an interface part of each of the plurality of sub-matrices;
(c) forming a global interface matrix by local Schur complements on diagonal blocks of the plurality of sub-matrices and connections between the plurality of sub-matrices on off-diagonal blocks;
(d) determining whether the global interface matrix is sufficiently small to satisfy a predefined size threshold;
(e) when determined that the global interface matrix is not sufficiently small to satisfy said predefined size threshold, partitioning the global interface matrix into a second plurality of sub-matrices using multi-level partitioning and repeating operations (b)-(d) for the second plurality of sub-matrices.

18. The method of claim 17 further comprising:
performing local reordering of each of the plurality of sub-matrices.

19. The method of claim 18 wherein said local reording is performed after step (a) and before step (b).

20. A method comprising:
applying a non-overlapping domain decomposition to an original matrix to partition the original matrix into p parts using p-way multi-level partitioning, thereby forming a plurality of sub-matrices;
predefining a maximally allowed number of recursion levels;
predefining a minimum size threshold that specifies a minimally allowed number of rows of an interface matrix relative to size of the original matrix;
recursively performing operations (a)-(d):
(a) performing, in parallel by a plurality of parallel processing units, for each of the plurality of sub-matrices: i) a parallel truncated factorization of diagonal blocks, and ii) forming of a local Schur complement for an interface part of each sub-matrix;
(b) implicitly forming a global interface matrix by local Schur complements on diagonal blocks and connections between sub-matrices on off-diagonal blocks;
(c) determining whether either the predefined maximally allowed number of recursion levels is reached or the size of the global interface matrix is less than the predefined minimize size threshold;
(d) when determined in operation (c) that the predefined maximally allowed number of recursion levels is not reached and the size of the global interface matrix is not less than the predefined minimize size threshold, partitioning the global interface matrix into a further plurality of sub-matrices using multi-level partitioning and repeating operations (a)-(d) for the further plurality of sub-matrices.

21. The method of claim 20 further comprising:
when determined in operation (c) that either the predefined maximally allowed number of recursion levels is reached or the size of the global interface matrix is less than the predefined minimize size threshold, ending the recursive processing.

22. The method of claim 21 further comprising:
when determined in operation (c) that either the predefined maximally allowed number of recursion levels is reached or the size of the global interface matrix is less than the predefined minimize size threshold, factorizing the global interface matrix.

23. The method of claim 20 further comprising:
performing local reordering of each of the plurality of sub-matrices.

24. The method of claim 23 wherein the reordering comprises:
first reordering interior rows of each of the plurality of sub-matrices; and
then reordering interface rows of the plurality of sub-matrices.

25. The method of claim 20 wherein said implicitly forming comprises:
storing, by each of the plurality of parallel processing units, a respective part of the interface matrix.
